(19) United States
(12) Patent Application Publication
(10) Pub. No.: US 2026/0057644 A1
(43) Pub. Date: Feb. 26, 2026

(54) IMAGE RECOGNITION METHOD AND IMAGE RECOGNITION DEVICE

(71) Applicant: Vivotek Inc., New Taipei City (TW)

(72) Inventor: Chao-Tan Huang, New Taipei City (TW)

(73) Assignee: Vivotek Inc., New Taipei City (TW)

(21) Appl. No.: 19/295,728

(22) Filed: Aug. 11, 2025

(30) Foreign Application Priority Data
Aug. 22, 2024 (TW) 113131522

(51) Int. Cl. G06V 10/74; G06V 10/40; G06V 10/764

(52) U.S. Cl. CPC G06V 10/761; G06V 10/40; G06V 10/764; G06V 2201/07

(57) ABSTRACT

An image recognition method is applied to an image recognition device and used to determine whether the same target object is existed in different images. The image recognition method includes analyzing two continuous images of an image stream to respectively search two target objects and acquire a plurality of feature vectors of the two target objects, computing two distances of the two target objects respectively relative to one reference point of the two continuous images, utilizing the two distances to acquire a corresponding weight of partial feature vectors of the plurality of feature vectors, and utilizing the corresponding weight to adjust the partial feature vectors for generating similarity of the two target objects.

### BACKGROUND OF THE INVENTION

### 1. Field of the Invention

The present invention relates to an image recognition method and an image recognition device, and more particularly, to an image recognition method of determining object similarity and a related image recognition device.

### 2. Description of the Prior Art

With the advanced technology, the conventional surveillance apparatus is widely used in various regions, and can accurately and quickly recognize whether a special condition is occurred. When the surveillance apparatus is used to detect the car, the type, position, speed and direction of the car can be recognized; an outline of the car is not changed abnormally. When the surveillance apparatus is used to detect the human, the gender, position, speed and direction of the human can be recognized, but its detection accuracy may be decreased if the human changes the posture. For example, compared to the standing posture or walking posture, an outline of the human is changed significantly when the human squats, lies down, crawls or climbs, and the conventional surveillance apparatus may produce an erroneous detection result due to the above-mentioned changes in the human's movement and outline. Therefore, design of an image recognition method that can continuously analyze and track whether an object with different appearances in different images belong to the same object is an important issue in the related surveillance industry.

### SUMMARY OF THE INVENTION

The present invention provides an image recognition method of determining object similarity and a related image recognition device for solving above drawbacks.

According to one embodiment, an image recognition method is applied to an image recognition device having an image receiver and an operation processor, and adapted to determine whether different images contain the same target object. The image recognition method includes searching two target objects respectively in two continuous images of an image stream from the image receiver so as to extract a plurality of feature vectors of the two target objects, computing two distances of the two target objects respectively relative to reference points of the two continuous images, utilizing the two distances to acquire a corresponding weight of partial feature vectors of the plurality of feature vectors, and utilizing the corresponding weight to adjust the partial feature vectors for generating similarity of the two target objects.

According to another embodiment, an image recognition device includes an image receiver and an operation processor. The image receiver is adapted to receive an image stream. The operation processor is electrically connected with the image receiver, and adapted to search two target objects respectively in two continuous images of the image stream so as to extract a plurality of feature vectors of the two target objects, compute two distances of the two target objects respectively relative to reference points of the two continuous images, utilize the two distances to acquire a corresponding weight of partial feature vectors of the plurality of feature vectors, and utilize the corresponding weight to adjust the partial feature vectors for generating similarity of the two target objects.

The image recognition method and the image recognition device of the present invention can be applied to the school wall. The surveillance range of the image recognition method can contain an inner side and an outer side of the wall, and be used to detect whether the target object (e.g., the human) crosses the wall. The image recognition method can recognize the target object by machine learning; the walking posture of different target objects (e.g., the human) do not change much, and have preferred recognition accuracy. If the target object (e.g., the human) is changed from the walking posture or the standing posture to the squatting posture, the lying down posture, the crawling posture or the climbing posture, an outline of the target object may be changed significantly and more difficult to recognize, so the present invention can use other category of the feature vector (i.e., the attribute) that is not affected by motion to assist the recognition.

The image recognition method and the image recognition device of the present invention can adjust the feature vector that is affected by motion (i.e., the posture feature defined as the object classification) and the feature vector that is not affected by motion (i.e., the color feature defined as the attribute) respectively by different weights, in accordance with the relative distance between the target object (i.e., the human) and the reference point (i.e., the wall), so as to increase influence of consistent feature (i.e., the color feature) and further exclude or reduce influence of inconsistent feature (i.e., the posture feature), and further to compute the similarity of the multiple target objects in different images, for determining whether the multiple target objects belong to the same target object in continued object tracking operation.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of an image recognition device according to an embodiment of the present invention.

FIG. 2 and FIG. 3 are application diagrams of the image recognition device in different situations according to the embodiment of the present invention.

FIG. 4 is a flow chart of the image recognition method according to the embodiment of the present invention.

FIG. 5 and FIG. 6 are diagrams of images acquired by the image recognition device 10 in different situations according to the embodiment of the present invention.

FIG. 7 and FIG. 8 are diagrams of a regression result of the weight and the distances according to different embodiments of the present invention.

### DETAILED DESCRIPTION

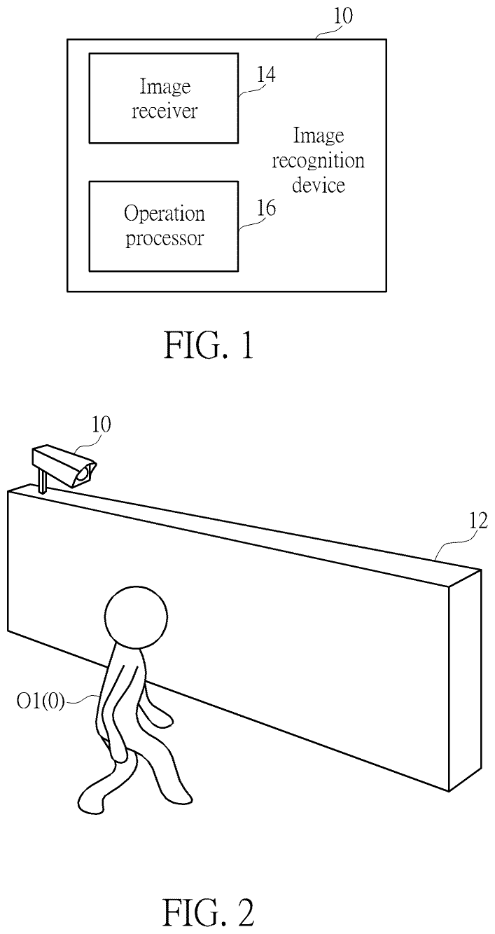

Please refer to FIG. 1 to FIG. 3 FIG. 1 is a functional block diagram of an image recognition device 10 according to an embodiment of the present invention. FIG. 2 and FIG. 3 are application diagrams of the image recognition device 10 in different situations according to the embodiment of the present invention. The image recognition device 10 can be a surveillance camera, or any electronic apparatus with a surveillance function. The image recognition device 10 can be installed on various types of surveillance regions (e.g., the road, the school or the factory) and used to recognize abnormal situations. In the embodiment of the present invention, the image recognition device 10 can be installed on the wall 12, and can detect whether a target object O is appeared near by the wall 12, and further detect whether the target object O crosses the wall 12.

The image recognition device 10 can include an image receiver 14 and an operation processor 16 electrically connected with each other. The image receiver 14 can directly capture an image stream with a surveillance range covering the surveillance region, or can receive the image stream captured by an external electronic apparatus and having the surveillance range covering the surveillance region. The operation processor 16 can be electrically connected with the image receiver 14 in a wired manner or in a wireless manner, and can analyze the image stream to execute an image recognition method of the present invention. For example, the image recognition device 10 can determine whether two continuous images of the image stream contain the same target object O, and further determine different images contain the same target object O that show different behaviors (e.g., walking or climbing the wall), or different images contain different target objects O.

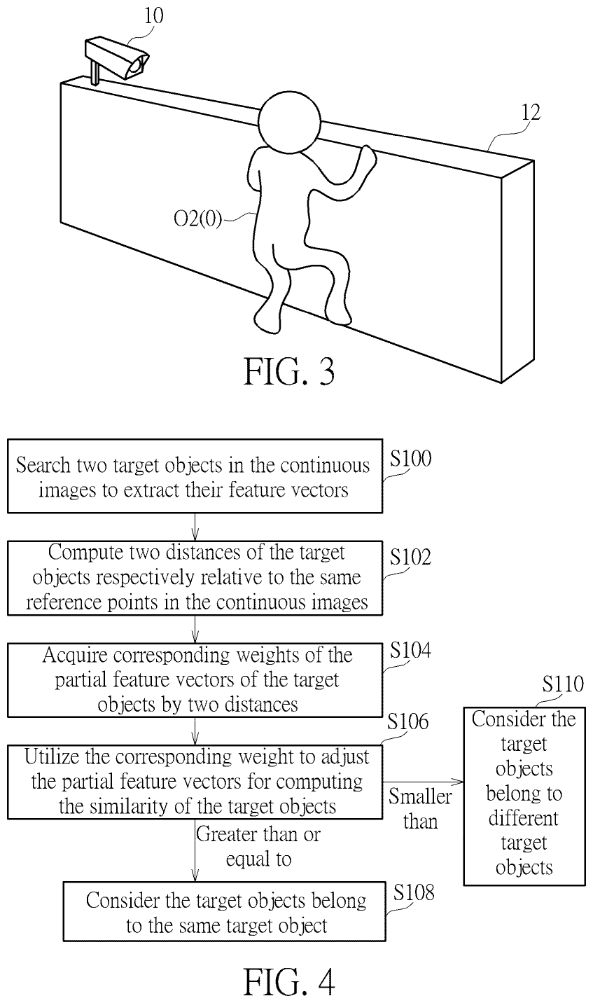

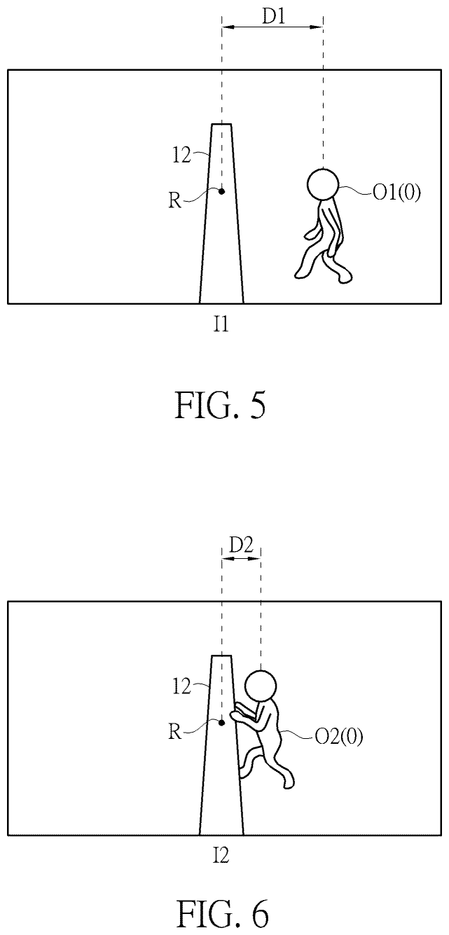

Please refer to FIG. 4 to FIG. 6. FIG. 4 is a flow chart of the image recognition method according to the embodiment of the present invention. FIG. 5 and FIG. 6 are diagrams of images I1 and I2 acquired by the image recognition device 10 in different situations according to the embodiment of the present invention. The image recognition method illustrated in FIG. 4 can be suitable for the image recognition device 10 shown in FIG. 1 to FIG. 3. Regarding the image recognition method, step S100 can be executed to search out two target objects O1 and O2 respectively in the continuous images I1 and I2 of the image stream and further to extract a plurality of feature vectors of the target objects O1 and O2. The image recognition method can acquire feature vectors of multiple categories of each target object O, such as a posture feature without consistency due to motion affect, and color feature with the consistency that is not affected by the motion; an actual application is not limited to foresaid two categories, and depends on a design demand.

For example, the image I1 can be a previous image of the continuous images, and the target object O1 can be a previous target object O in the previous image. The feature vector of the multiple categories of the target object O1 can include, but not be limited to, a first feature vector classified as a category about the posture feature, and a second feature vector classified as a category about the color feature. Accordingly, the image 12 can be a subsequent image of the continuous images, and the target object O2 can be a subsequent target object O in the subsequent image. The feature vector of the multiple categories of the target object O2 can include, but not be limited to, a third feature vector classified as a category about the posture feature, and a fourth feature vector classified as a category about the color feature.

Then, step S102 can be executed to compute two distances D1 and D2 of the target objects O1 and O2 respectively relative to reference points R in the two continuous images I1 and I2. In the present invention, lens position of the image recognition device 10 can be preferably kept unchanged, and the wall 12 is kept at a fixed position and can be considered as the same wall in different images I1 and I2 for defining the reference point R.

The reference point R can be a mass center, a gravity center, or a geometric center of the certain item (e.g., the wall in the embodiment) in the two continuous images I1 and I2, or can be an edge point of the certain item (e.g., the wall in the embodiment) having a shortest distance relative to the target object (e.g., the target object O1 or O2); an actual application of the reference point R can depend on the design demand. Accordingly, the distances D1 and D2 can be a shortest distance between the reference point R and the mass center, the gravity center, or the geometric center of the target object (e.g., the target object O1 or O2), or can be a shortest distance between the reference point R and an edge point of the target object O1 or O2 that has the shortest distance to the certain item (e.g., the wall in the embodiment); actual application of the distance D1 or D2 can depend on the design demand. If the target object (e.g., the target object O1 or O2) is a human, the distances D1 and D2 can be computed as a shortest distance between the certain item (e.g., the wall in the embodiment) and a portion (such as a top of the head, or a bottom of the feet touching the ground), or a closest point on a bounding box generated by human detection. In addition, the embodiment can define the reference point R on the wall; however, a hole on the path, a low building, or a tunnel may be optionally defined as the reference point R. Variation of the reference point R can depend on the design demand.

Then, step S104 can be executed to acquire corresponding weights of partial feature vectors of all the feature vectors about the target objects O1 and O2 by the two distances D1 and D2. Therefore, the first feature vector (such as the posture feature) of the target object O1 and the third feature vector (such as the posture feature) of the target object O2 can have a first weight (such as a posture weight), and the second feature vector (such as the color feature) of the target object O1 and the fourth feature vector (such as the color feature) of the target object O2 can have a second weight (such as the color weight).

It should be mentioned that the feature vector may at least include two definitions: an object classification and an attribute. The object classification can be the foresaid posture feature, or other human feature that is affected by the motion, and feature recognition of the object classification can be varied in accordance with deformation of the target objects O1 and O2. A corresponding weight of the feature vector about the object classification can be positively adjusted in accordance with change of the two distances D1 and D2, which means the corresponding weight can be increased in response to increase of the distance from the wall (or the reference point R), and can be decreased in response to decrease of the distance from the wall. The attribute can be the foresaid color feature, or other clothing feature (e.g., the shoes or the hat) that is less affected by the motion. The attribute can have an anti-deformation property used to maintain feature recognition when the target objects O1 and O2 are deformed in the continuous images I1 and I2. The corresponding weight of the feature vector about the attribute can be inversely adjusted in accordance with change of the two distances D1 and D2, which means the corresponding weight can be decreased in response to increase of the distance from the wall (or the reference point R), and can be increased in response to decrease of the distance from the wall. Even if the target object O1 or O2 is not identified as the object, a changed area on the object can be identified by motion detection for computing the attribute of the changed area.

As mentioned above, the image recognition method can utilize the first weight and the second weight to respectively adjust reliability of the first feature vector of the target object O1 and the third feature vector of the target object O2, and reliability of the second feature vector of the target object O1 and the fourth feature vector of the target object O2 in opposite trends. The reliability can be interpreted as recognition accuracy provided by the partial feature vectors in computation of the similarity. For example, the first weight (such as the posture weight) can be decreased and the second weight (such as the color weight) can be increased when being close to the wall 12 (or the reference point R), and the first weight (such as the posture weight) can be increased and the second weight (such as the color weight) can be decreased when being away from the wall 12 (or the reference point R).

The corresponding weight of the feature vector in different definitions can be acquired by a specific computation formula (e.g., the interpolation formula or the discrete formula). Further, a storage module (which is not marked in the figures) of the image recognition device 10 may have a built-in preset lookup table, which can store the corresponding weights relevant to the two distances D1 and D2 and the feature vector in different definitions. Computation and acquisition of the weight are not limited to the foresaid embodiment, and other possible embodiment can be omitted herein for simplicity.

Then, step S106 can be executed to utilize the corresponding weight to adjust the partial feature vectors in the plurality of feature vectors for computing the similarity of the target objects O1 and O2, and compare the similarity with a preset threshold. When the similarity is greater than or equal to the preset threshold, its means that similarity possibility meets expectation, and step S108 can be executed to consider that the target objects O1 and O2 can belong to the same target object O, and object tracking can be continued in other images after the image I2. When the similarity is smaller than the preset threshold, its means that similarity possibility does not meet expectation, and step S110 can be executed to consider that the target objects O1 and O2 can belong to different target objects O. The foresaid preset threshold can be computed based on the property of the target objects O1 and O2, and the detailed description is omitted herein for simplicity.

In step S106, the image recognition method of the present invention can acquire the similarity by dividing a product of the partial feature vectors and the corresponding weight by a product of each absolute value of the partial feature vectors, as Formula 1. A symbol “Sc” can be interpreted as the similarity. A symbol “A” can be interpreted as the feature vector of the target object O1 in the image I1. A symbol “B” can be interpreted as the feature vector of the target object O2 in the image I2. A symbol “W” can be interpreted as the corresponding weight provided by the feature vectors of the symbol “A” and the symbol “B”. In addition to dot product distance technique, which is computed by a product of lengths of the plurality of feature vectors A and B and cosine of included angle(s) between the plurality of said feature vectors A and B, the similarity can also be computed by using cosine distance technique that measures the similarity of the plurality of feature vectors by included angle(s) between the plurality of said feature vectors, or by using Pearson similarity computation after cosine of included angle(s) between the plurality of feature vectors is normalized; actual application of the functional operation is not limited to foresaid embodiments.

$$Sc = \frac{{\sum }_{i = 1}^{n} {A}_{i} {B}_{i} {W}_{i}}{\sqrt{{\sum }_{i = 1}^{n} {A}_{i}^{2}} \cdot \sqrt{{\sum }_{i = 1}^{n} {B}_{i}^{2}}} \qquad Formula 1$$

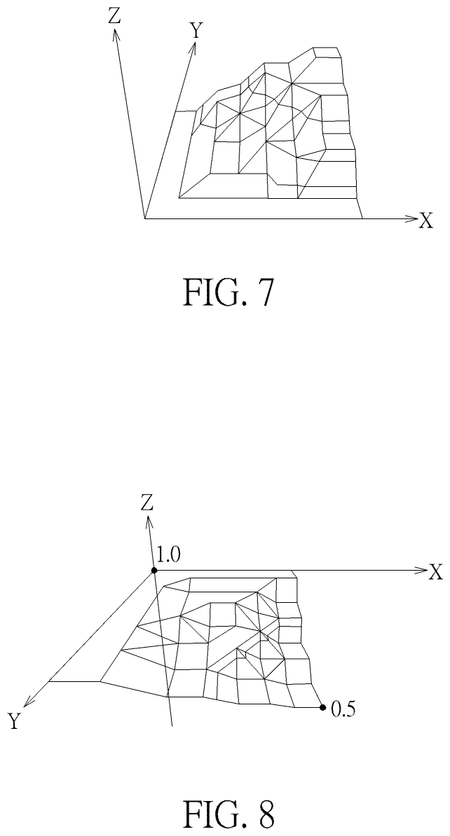

Please refer to FIG. 7 and FIG. 8. FIG. 7 and FIG. 8 are diagrams of a regression result of the symbol “W” and the distances D1 and D2 according to different embodiments of the present invention. As shown in FIG. 7, X-axis can correspond to the distance D1, and Y-axis can correspond to the distance D2, and Z-axis can correspond to the weight W (e.g., the foresaid first weight). When the target objects O1 and O2 are away from the wall 12, the first weight (such as the posture weight) can be increased accordingly; when the target objects O1 and O2 are close to the wall 12, the first weight (such as the posture weight) can be decreased accordingly. As shown in FIG. 8, the X-axis can correspond to the distance D1, and Y-axis can correspond to the distance D2, and Z-axis can correspond to the weight W (e.g., the foresaid second weight). When the target objects O1 and O2 are away from the wall 12, the second weight (such as the color weight) can be decreased accordingly; when the target objects O1 and O2 are close to the wall 12, the second weight (such as the color weight) can be increased accordingly. The regression function relevant to the posture weight and/or the color weight can refer to Formula 2 or Formula 3. Symbols “a”, “b”, “1c”, “d”, “e” and “f” are adjustment parameters; values and function change can depend on the design demand.

$$W = a \times D 1 + b \times D 2 + c \qquad Formula 2$$

$$W = a \times D {1}^{2} + b \times D 1 \times D 2 + c \times D {2}^{2} + d \times D 1 + e \times D 2 + f \qquad Formula 3$$

In conclusion, the image recognition method and the image recognition device of the present invention can be applied to the school wall. The surveillance range of the image recognition method can contain an inner side and an outer side of the wall, and be used to detect whether the target object (e.g., the human) crosses the wall. The image recognition method can recognize the target object by machine learning; the walking posture of different target objects (e.g., the human) do not change much, and have preferred recognition accuracy. If the target object (e.g., the human) is changed from the walking posture or the standing posture to the squatting posture, the lying down posture, the crawling posture or the climbing posture, an outline of the target object may be changed significantly and more difficult to recognize, so the present invention can use other category of the feature vector (i.e., the attribute) that is not affected by motion to assist the recognition.

The image recognition method and the image recognition device of the present invention can adjust the feature vector that is affected by motion (i.e., the posture feature defined as the object classification) and the feature vector that is not affected by motion (i.e., the color feature defined as the attribute) respectively by different weights, in accordance with the relative distance between the target object (i.e., the human) and the reference point (i.e., the wall), so as to increase influence of consistent feature (i.e., the color feature) and further exclude or reduce influence of inconsistent feature (i.e., the posture feature), and further to compute the similarity of the multiple target objects in different images, for determining whether the multiple target objects belong to the same target object in continued object tracking operation.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An image recognition method applied to an image recognition device having an operation processor for determining whether different images contain the same target object, the image recognition method comprising:
the operation processor device searching two target objects respectively in two continuous images of an image stream so as to extract a plurality of feature vectors of the two target objects;
the operation processor computing two distances of the two target objects respectively relative to a reference point of each of the two continuous images;
the operation processor utilizing the two distances to acquire a corresponding weight of partial feature vectors of the plurality of feature vectors; and
the operation processor utilizing the corresponding weight to adjust the partial feature vectors for generating similarity of the two target objects.

2. The image recognition method of claim 1, further comprising:
the operation processor deciding the two target objects belong to the same target object when the similarity is greater than or equal to a preset threshold; or
the operation processor deciding the two target objects belong to different target objects when the similarity is smaller than the preset threshold;
wherein the preset threshold is computed by a property of the two target objects.

3. The image recognition method of claim 1, wherein when the partial feature vectors are defined as an object classification, the corresponding weight is positively adjusted in accordance with change of the two distances; when the partial feature vectors are defined as an attribute, the corresponding weight is inversely adjusted in accordance with change of the two distances.

4. The image recognition method of claim 3, wherein feature recognition of the object classification is varied in accordance with deformation of the two target objects, the attribute has an anti-deformation property in the two target objects and is adapted to maintain the feature recognition when the two target objects are deformed in the two continuous images.

5. The image recognition method of claim 1, further comprising:
the operation processor receiving the image stream so as to set the reference point in each of the two continuous images of the image stream.

6. The image recognition method of claim 1, wherein extracting the plurality of feature vectors of the two target objects respectively in the two continuous images comprises:
the operation processor analyzing a first feature vector and a second feature vector of a previous target object in a previous image of the two continuous images; and
the operation processor analyzing a third feature vector corresponding to the first feature vector and a fourth feature vector corresponding to the second feature vector of a subsequent target object in a subsequent image of the two continuous images.

7. The image recognition method of claim 6, wherein utilizing the two distances to acquire the corresponding weight of the partial feature vectors of the plurality of feature vectors comprises:
the operation processor acquiring a first weight relevant to the first feature vector and the third feature vector and a second weight relevant to the second feature vector and the fourth feature vector in accordance with the two distances.

8. The image recognition method of claim 7, wherein utilizing the corresponding weight to adjust the partial feature vectors for generating the similarity of the two target objects comprises:
the operation processor utilizing the first weight and the second weight to respectively adjust reliability of the first feature vector and the third feature vector and reliability of the second feature vector and the fourth feature vector in opposite trends.

9. The image recognition method of claim 1, wherein the operation processor acquires the similarity by dividing a product of the partial feature vectors and the corresponding weight by a product of absolute values of the partial feature vectors.

10. The image recognition method of claim 1, wherein the operation processor acquires the similarity by cosine distance of measuring included angles between the plurality of feature vectors, or by Pearson similarity computation of normalizing cosine of the included angles between the plurality of feature vectors.

11. An image recognition device comprising:
an image receiver adapted to receive an image stream; and
an operation processor electrically connected with the image receiver, and adapted to search two target objects respectively in two continuous images of the image stream so as to extract a plurality of feature vectors of the two target objects, compute two distances of the two target objects respectively relative to a reference point of each of the two continuous images, utilize the two distances to acquire a corresponding weight of partial feature vectors of the plurality of feature vectors, and utilize the corresponding weight to adjust the partial feature vectors for generating similarity of the two target objects.

12. The image recognition device of claim 11, wherein the operation processor is adapted to further decide the two target objects belong to the same target object when the similarity is greater than or equal to a preset threshold, or decide the two target objects belong to different target objects when the similarity is smaller than the preset threshold, the preset threshold is computed by a property of the two target objects.

13. The image recognition device of claim 11, wherein when the partial feature vectors are defined as an object classification, the corresponding weight is positively adjusted in accordance with change of the two distances; when the partial feature vectors are defined as an attribute, the corresponding weight is inversely adjusted in accordance with change of the two distances.

14. The image recognition device of claim 13, wherein feature recognition of the object classification is varied in accordance with deformation of the two target objects, the attribute has an anti-deformation property in the two target objects and is adapted to maintain the feature recognition when the two target objects are deformed in the two continuous images.

15. The image recognition device of claim 11, wherein the operation processor is adapted to further receive the image stream from the image receiver so as to set the reference point in each of the two continuous images of the image stream.

16. The image recognition device of claim 11, wherein the operation processor is adapted to further analyze a first feature vector and a second feature vector of a previous target object in a previous image of the two continuous images, and analyze a third feature vector corresponding to the first feature vector and a fourth feature vector corresponding to the second feature vector of a subsequent target object in a subsequent image of the two continuous images.

17. The image recognition device of claim 16, wherein the operation processor is adapted to further acquire a first weight relevant to the first feature vector and the third feature vector and a second weight relevant to the second feature vector and the fourth feature vector in accordance with the two distances.

18. The image recognition device of claim 17, wherein the operation processor is adapted to further utilize the first weight and the second weight to respectively adjust reliability of the first feature vector and the third feature vector and reliability of the second feature vector and the fourth feature vector in opposite trends.

19. The image recognition device of claim 11, wherein the operation processor acquires the similarity by dividing a product of the partial feature vectors and the corresponding weight by a product of absolute values of the partial feature vectors.

20. The image recognition device of claim 11, wherein the operation processor acquires the similarity by cosine distance of measuring included angles between the plurality of feature vectors, or by Pearson similarity computation of normalizing cosine of the included angles between the plurality of feature vectors.
